(19) United States
(12) Patent Application Publication
(10) Pub. No.: US 2022/0108243 A1
(43) Pub. Date: Apr. 7, 2022

(54) WORK MANAGEMENT DEVICE, WORK MANAGEMENT SYSTEM, OPERATION MACHINE, WORK MANAGEMENT METHOD, AND PROGRAM

(71) Applicant: Komatsu Ltd., Tokyo (JP)

(72) Inventors: Chikashi Shike, Tokyo (JP); Takeshi Nakamura, Tokyo (JP)

(73) Assignee: Komatsu Ltd., Tokyo (JP)

(21) Appl. No.: 17/429,364

(22) PCT Filed: Nov. 18, 2019
(86) PCT No.: PCT/JP2019/045017

§ 371 Date: Aug. 9, 2021

(30) Foreign Application Priority Data
Feb. 26, 2019 (JP) 2019-033036

(51) Int. Cl. G06Q 10/06

(52) U.S. Cl. CPC G06Q 10/06313; G06Q 10/0633; G06Q 10/06316

(57) ABSTRACT

A work management device includes a present topography acquisition unit which acquires a present topography at a work site, a final design surface acquisition unit which acquires a final design surface at the work site, a work area acquisition unit which acquires a work area of an operation machine at the work site, a target operation volume acquisition unit which acquires a target operation volume per unit time of the operation machine, an intermediate design surface generation unit which generates an intermediate design surface for the operation machine on the basis of the final design surface, the present topography, the work area, and the target operation volume per unit time, and a notification processing unit which notifies the intermediate design surface to an operator of the operation machine.

### TECHNICAL FIELD

The present invention relates to a work management device, a work management system, an operation machine, a work management method, and a program.

### BACKGROUND ART

At a work site in which a plurality of operation machines work at their respective positions, the actual performance as a work volume per day may vary due to an unclear daily target work volume for each operation machine, and thereby a situation in which the work does not proceed as planned may occur.

Therefore, a site manager creating an intermediate design surface, which is a target of daily work, and giving instructions thereof to each operation machine has been studied.

Patent Literature 1 describes that work content to be performed within the day is graphically displayed for each of operation machines.

### CITATION LIST

### Patent Literature

[Patent Literature 1]
Japanese Unexamined Patent Publication, First Publication No. 2002-188183

### SUMMARY OF INVENTION

### Technical Problem

When the above-described work management is performed, it is required to appropriately set a goal (intermediate design surface) of the operation machine for each unit time (for example, one day).

An objective of the present invention is to appropriately set a target of work for a unit time for each of a plurality of operation machines.

### Solution to Problem

According to one aspect of the present invention, a work management device includes a final design surface acquisition unit which acquires a final design surface at a work site, a present topography acquisition unit which acquires a present topography at the work site, a work area acquisition unit which acquires a work area of an operation machine at the work site, a target operation volume acquisition unit which acquires a target operation volume per unit time of the operation machine, an intermediate design surface generation unit which generates an intermediate design surface for the operation machine on the basis of the final design surface, the present topography, the work area, and the target operation volume per unit time, and a notification processing unit which notifies the intermediate design surface to an operator of the operation machine.

### Advantageous Effects of Invention

According to the above-described aspect, it is possible to appropriately set a target of work for a unit time for each of a plurality of operation machines.

### BRIEF DESCRIPTION OF DRAWINGS

FIG. 1 is a view illustrating an overall configuration of a work management system according to a first embodiment.

FIG. 2 is a diagram showing a functional configuration of a work management device and the like according to the first embodiment.

FIG. 3 is a diagram showing an example of operation machine information according to the first embodiment.

FIG. 4 is a diagram showing a processing flow of the work management device according to the first embodiment.

FIG. 5 is a diagram showing a processing flow of the work management device according to the first embodiment.

FIG. 6 is a diagram showing a processing flow of the work management device according to the first embodiment.

FIG. 7 is a diagram showing a processing flow of the work management device according to the first embodiment.

FIG. 8 is a view used for a detailed description on processing of the work management device according to the first embodiment.

FIG. 9 is a view used for a detailed description on processing of the work management device according to the first embodiment.

FIG. 10 is a view used for a detailed description on processing of the work management device according to the first embodiment.

FIG. 11 is a view used for a detailed description on processing of the work management device according to a modified example of the first embodiment.

FIG. 12 is a diagram used for a detailed description on processing of the work management device according to the modified example of the first embodiment.

### DESCRIPTION OF EMBODIMENTS

### First Embodiment

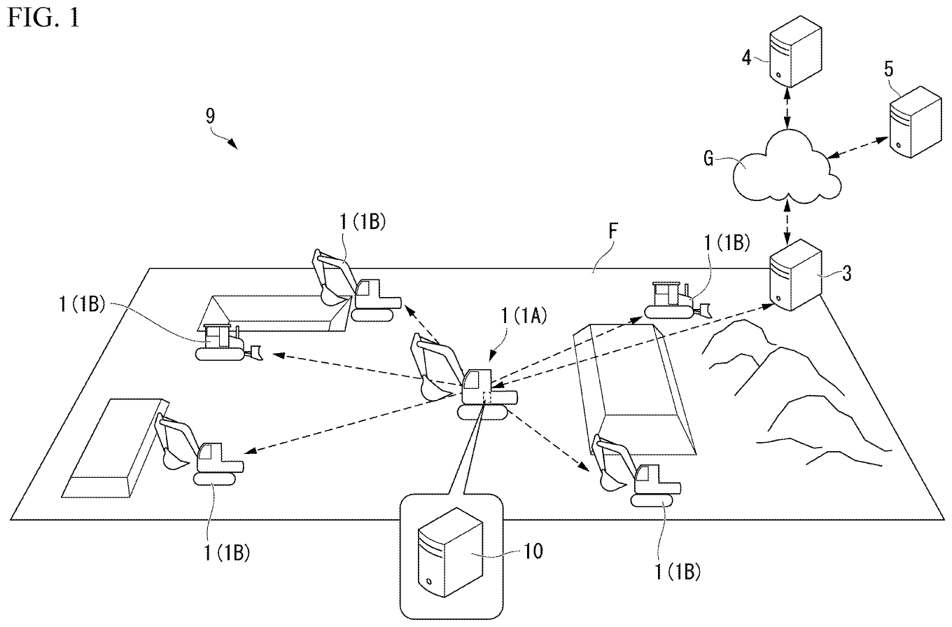

Hereinafter, a work management system according to a first embodiment will be described in detail with reference to FIGS. 1 to 10.

(Overall Configuration of Work Management System)

FIG. 1 is a view illustrating an overall configuration of a work management system according to the first embodiment.

As illustrated in FIG. 1, a work management system 9 includes a plurality of operation machines 1 for performing work at a work site F. The operation machine 1 is a general operation machine such as a power excavator, a bulldozer, or a wheel loader.

One of the plurality of operation machines 1 is equipped with a work management device 10. In the following description, the operation machines 1 are distinguished such that the operation machine 1 equipped with the work management device 10 is a lead operation machine 1A and the other operation machines 1 are subordinate operation machines 1B.

The lead operation machine 1A acts as a control tower and gives work instructions to the subordinate operation machines 1B. Specifically, the lead operation machine 1A notifies each of the subordinate operation machines 1B of a target of daily work, that is, an intermediate design surface as a goal of work of the day. An operator operating the subordinate operation machine 1B performs work of one day with the notified intermediate design surface as a target.

The work management device 10 generates an intermediate design surface for each of the operation machines 1. Also, the work management device 10 notifies each of the subordinate operation machines 1B of the generated intermediate design surface. A specific processing of the work management device 10 will be described later.

An edge processing computer 3 is a computer installed in a site office of the work site F or the like. The edge processing computer 3 collects information of various types from a drone (to be described later) capable of acquiring topographical information and each operation machine 1. Then, the edge processing computer 3 trims a weight (edge processing) of the collected information of various types and then transmits it to a server device 4 through a wide area network G. Further, the wide area network G is a so-called Internet communication network, a mobile communication network such as LTE and 3G, or the like.

The server device 4 sequentially updates and stores information (information indicating a present topography of the work site F, a state of each operation machine 1, or the like) received from the edge processing computer 3.

A computer 5 of a work company is a terminal device owned by the work company and can access the server device 4 and the edge processing computer 3 through the wide area network G.

(Functional Configuration of Work Management Device and the Like)

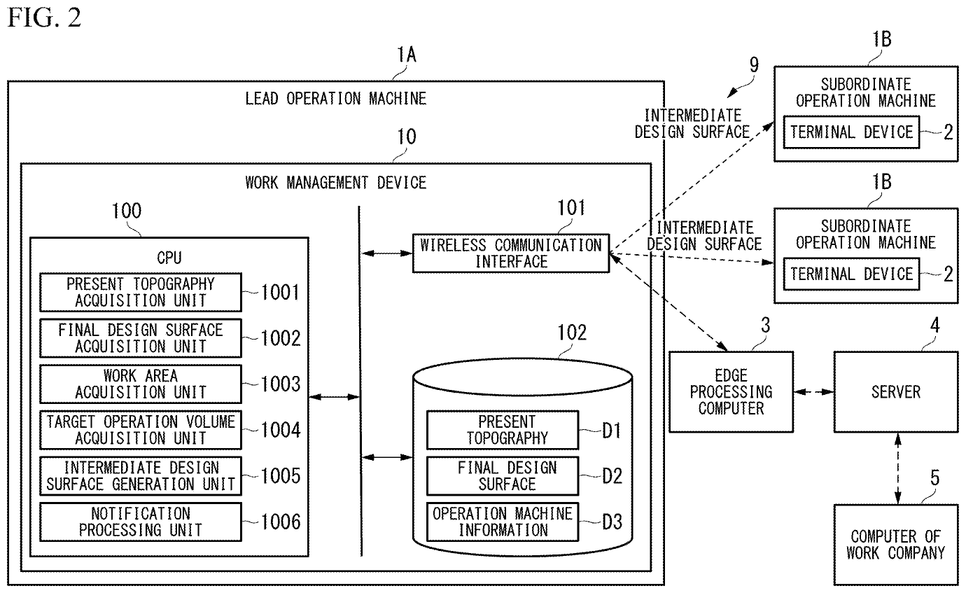

FIG. 2 is a diagram showing a functional configuration of the work management device and the like according to the first embodiment.

As shown in FIG. 2, the work management device 10 includes a CPU 100, a wireless communication interface 101, and a recording medium 102.

The CPU 100 is a processor that controls the entire operation of the work management device 10. The CPU 100 realizes each function to be described later by reading a program and data stored in the recording medium 102 or the like into a memory and executing processing specified in the program.

The wireless communication interface 101 is a communication interface for the work management device 10 to transmit and receive information to and from the subordinate operation machines 1B in the work site F wirelessly. The wireless communication interface 101 may be, for example, a communication interface of wireless LAN.

The recording medium 102 may be realized by, for example, a large-capacity recording device such as a hard disk drive (HDD) or a solid state drive (SSD), and store an operation system (OS), an application program, data of various types, or like. In the present embodiment, a present topography D1, a final design surface D2, and operation machine information D3 are recorded on the recording medium 102.

The present topography D1 is information indicating the topography of the present work site F and may be composed of, for example, three-dimensional point cloud data. The present topography D1 is acquired by flying a drone over the work site F after the work of one day ends. The drone is equipped with a stereo camera capable of imaging the ground from the sky above the work site F. The drone uses the stereo camera to thoroughly capture overhead view images while flying in the sky above the work site F. This overhead view images are transferred to the edge processing computer 3 and converted into data of the present topography D1 as three-dimensional point cloud data by the edge processing computer 3. The edge processing computer 3 transmits the data of the present topography D1 to the server device 4. The server device 4 records and updates the data of the present topography D1, converts it into three-dimensional point cloud data, and thereby the present topography D1 of the work site F is generated. In the present embodiment, the present topography D1 is acquired and updated for each day.

The work management device 10 receives the data of the present topography D1 from the server device 4 and records it on the recording medium 102 for each day.

The final design surface D2 is information indicating a final topography at the time when work of the work site F is completed. The final design surface D2 may be composed of, for example, three-dimensional point cloud data as in the present topography D1.

The final design surface D2 is recorded in the server device 4 in advance. The work management device 10 receives the final design surface D2 from the server device 4 and records it on the recording medium 102 in advance.

The operation machine information D3 is an information table in which information on each of the operation machines 1 performing work at the work site F is summarized. The information included in the operation machine information D3 will be described later. The operation machine information D3 is also recorded in the server device 4 in advance. The work management device 10 receives the operation machine information D3 from the server device 4 and records it on the recording medium 102 in advance.

A terminal device 2 is a terminal device mounted on each of the subordinate operation machines 1B and realizes communication between an operator (site manager) of the lead operation machine 1A and an operator of the subordinate operation machine 1B. For example, the terminal device 2 displays an intermediate design surface notified from the work management device 10 on a display or the like to present it to the operator of each subordinate operation machine 1B.

Next, functions included in the CPU 100 according to the present embodiment will be described in detail.

The CPU 100 has functions as a present topography acquisition unit 1001, a final design surface acquisition unit 1002, a work area acquisition unit 1003, a target operation volume acquisition unit 1004, an intermediate design surface generation unit 1005, and a notification processing unit 1006 by being operated according to a predetermined program.

The present topography acquisition unit 1001 acquires a present topography (the present topography D1) at the work site F with reference to the recording medium 102.

The final design surface acquisition unit 1002 acquires a final design surface (the final design surface D2) at the work site F with reference to the recording medium 102.

The work area acquisition unit 1003 acquires a work area of the operation machine 1 at the work site F. The term “work area” indicates a region of the work site F that each operation machine 1 is in charge of. The target operation volume acquisition unit 1004 acquires a target operation volume per unit time of the operation machine 1. The intermediate design surface generation unit 1005 generates an intermediate design surface for each operation machine 1 on the basis of the present topography acquired by the present topography acquisition unit 1001, the final design surface acquired by the final design surface acquisition unit 1002, the work area acquired by the work area acquisition unit 1003, and the target operation volume per unit time acquired by the target operation volume acquisition unit 1004.

The notification processing unit 1006 transmits each intermediate design surface generated by the intermediate design surface generation unit 1005 to the terminal device 2 of each subordinate operation machine 1B to notify each operator of it.

(Operation Machine Information)

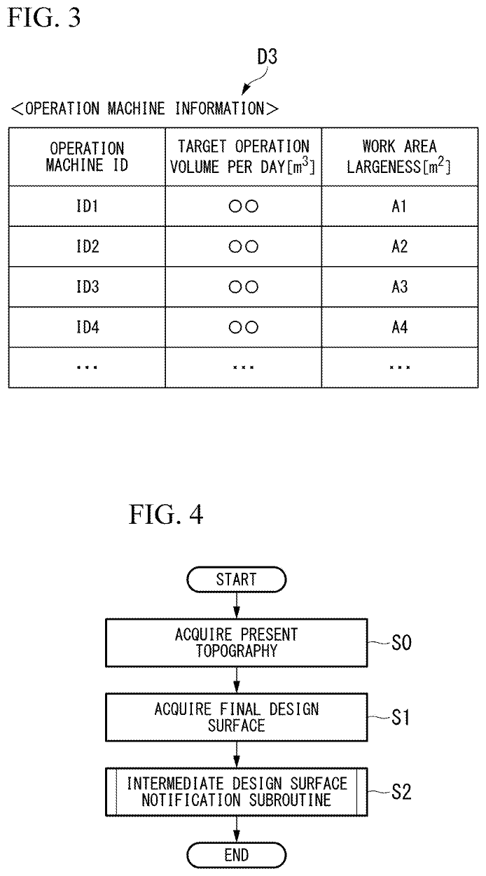

FIG. 3 is a diagram showing an example of operation machine information according to the first embodiment.

The operation machine information D3 recorded on the recording medium 102 will be described in detail with reference to FIG. 3.

As shown in FIG. 3, the operation machine information D3 is an information table formed by associating an “operation machine ID,” a “target operation volume per day,” and a “a work area largeness” for each operation machine 1 that performs work at the work site F.

The “operation machine ID” is an identifier assigned so that the operation machine 1 performing work at the work site F can be identified.

The “target operation volume per day” is information indicating a guideline for a work volume (soil volume) that each operation machine 1 can excavate per day and is a value related to a volume. The “target operation volume per day” is individually determined on the basis of specifications (model, rated output, bucket capacity, and the like) of the operation machine 1.

The “work area largeness” is information indicating a largeness of a range in which each operation machine 1 can work in daily work, and is a value related to an area. As in the “target operation volume per day,” the “work area largeness” is also individually determined on the basis of specifications (model, rated output, bucket capacity, and the like) of the operation machine 1.

(Processing Flow of Work Management Device)

FIGS. 4 to 7 are diagrams each showing a processing flow of the work management device according to the first embodiment.

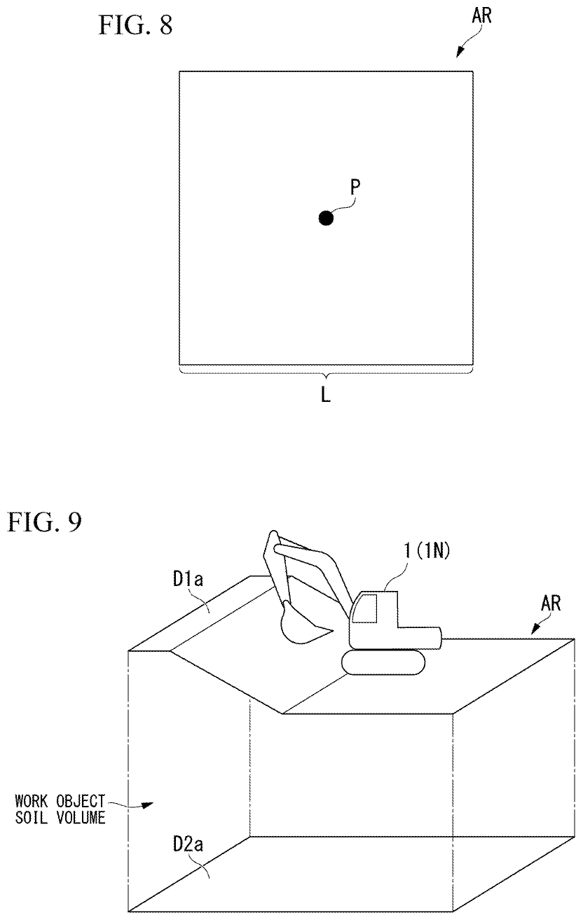

FIGS. 8 to 10 are views used for detailed description of processing of the work management device according to the first embodiment.

Hereinafter, a flow of processing of the work management device 10 according to the first embodiment will be described in detail with reference to FIGS. 4 to 10.

The processing flow shown in FIG. 4 is executed on the basis of an operation of an operator as the site manager who is on board the lead operation machine 1A at the start of work of a day.

When a predetermined operation is received from the site manager, the present topography acquisition unit 1001 of the work management device 10 acquires the present topography D1 recorded on the recording medium 102 (step S0). This present topography D1 is one showing a topographical shape of the work site F at the time of work end of the previous day.

Further, as described above, the present topography D1 is recorded in advance on the recording medium 102 by the work management device 10 receiving it from the server device 4 for each day.

Next, the final design surface acquisition unit 1002 of the work management device 10 acquires the final design surface D2 recorded on the recording medium 102 (step S1).

Further, as described above, the final design surface D2 is recorded in advance on the recording medium 102 by the work management device 10 receiving it from the server device 4 beforehand.

Next, the work management device 10 executes an intermediate design surface notification subroutine using the present topography D1 and the final design surface D2 acquired in steps S0 and S1 (step S2). In this intermediate design surface notification subroutine, the work management device 10 generates an intermediate design surface, which is a goal of the work for the day, for all the operation machines 1 (including the lead operation machine 1A in addition to the subordinate operation machines 1B) that perform work at the work site F and notifies each of the operation machines 1 of the intermediate design surface.

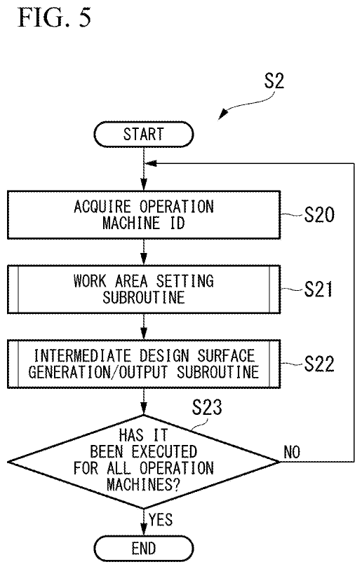

Hereinafter, processing of the intermediate design surface notification subroutine (step S2) will be described in detail with reference to FIGS. 5 to 7.

As shown in FIG. 5, the work management device 10 acquires one of the operation machine IDs recorded in the operation machine information D3 (see FIG. 3) (step S20).

As described above, the operation machine information D3 is recorded in advance on the recording medium 102 by the work management device 10 receiving it from the server device 4 beforehand.

The work management device 10 executes a work area setting subroutine (step S21) and an intermediate design surface generation/output subroutine (step S22) for the operation machine 1 specified by one operation machine ID acquired in step S20.

The work management device 10 determines whether or not the work area setting subroutine (step S21) and the intermediate design surface generation/output subroutine (step S22) have been executed for all the operation machines 1 (step S23).

When the work area setting subroutine and the intermediate design surface generation/output subroutine have not been executed for all the operation machine IDs (step S23; NO), the work management device 10 returns the processing to step S20 to acquire another operation machine ID and executes the work area setting subroutine and the intermediate design surface generation/notification subroutine for the operation machine ID.

When the work area setting subroutine and the intermediate design surface generation/notification subroutine have been executed for all the operation machine IDs (step S23; YES), the work management device 10 completes the intermediate design surface notification subroutine (step S2).

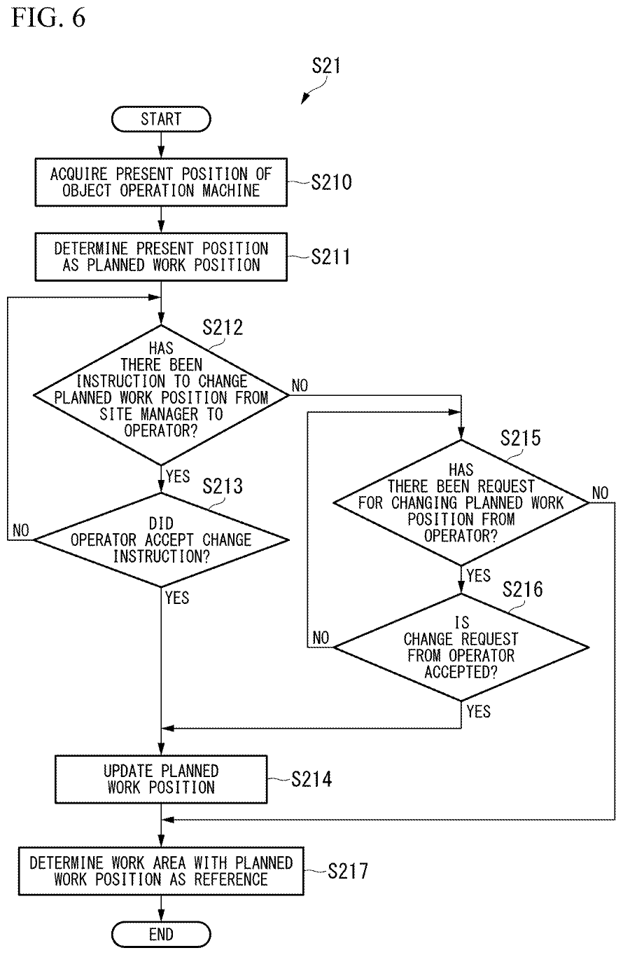

The work area setting subroutine (step S21) will be described in detail with reference to FIG. 6.

The work management device 10 executes the following processing on the operation machine 1 specified by the operation machine ID acquired in step S20. In the following description, one operation machine 1 specified by the operation machine ID acquired in step S20 will also be referred to as an “object operation machine.”

The work area acquisition unit 1003 of the work management device 10 acquires a present position of the object operation machine (step S210). Here, the operation machine 1 according to the present embodiment is equipped with a global navigation satellite system (GNSS) receiver and is capable of acquiring positioning information based on radio waves from satellites. The work area acquisition unit 1003 can acquire a present position of the object operation machine by receiving positioning information from the object operation machine.

The work area acquisition unit 1003 determines the present position acquired in step S210 as a “planned work position” of the object operation machine (step S211). The term “planned work position” indicates a position serving as a reference (a reference position for a work area) when the object operation machine performs the work for the day. With the processing of step S211, the work area acquisition unit 1003 provisionally determines the present position of the object operation machine observed at the start of work as the “planned work position” of the object operation machine.

The site manager on board the lead operation machine 1A formally determines the planned work position of each subordinate operation machine 1B through dialogue with the operator of each subordinate operation machine 1B. Specifically, this proceeds as follows.

First, when the site manager wants to change the planned work position of the object operation machine, he/she operates the work management device 10 to transmit an instruction to change the planned work position to the operator of the object operation machine. At this time, the work area acquisition unit 1003 receives an input of the instruction to change the planned work position for the object operation machine on the basis of the operation of the site manager (step S212).

When the input of the instruction to change the planned work position is received from the site manager (step S212; YES), the work area acquisition unit 1003 transmits the change instruction to the terminal device 2 of the object operation machine. The operator of the object operation machine chooses whether or not to accept this change instruction and inputs it to the terminal device 2. The work area acquisition unit 1003 immediately receives the information that has been input to the terminal device 2 (step S213).

When the operator of the object operation machine does not accept the change instruction (step S213; NO), the work area acquisition unit 1003 returns the processing to step S212.

When the operator of the object operation machine accepts the change instruction (step S213; YES), the work area acquisition unit 1003 updates the planned work position of the object operation machine to the position designated by the change instruction in step S212 (step S214).

In this way, the work area acquisition unit 1003 acquires the planned work position of the object operation machine on the basis of the instruction from the site manager to the operator.

On the other hand, when there is no input of an instruction to change the planned work position from the site manager (step S212; NO), the work area acquisition unit 1003 determines whether or not a request for changing the planned work position has been received from the operator of the object operation machine (step S215). Here, there are also cases in which the operator of the object operation machine hopes to change the planned work position. In this case, the operator of the object operation machine operates the terminal device 2 to transmit a request for changing the planned work position to the site manager who is on board the lead operation machine 1A.

When the request for changing the planned work position is received from the operator of the object operation machine (step S215; YES), the work area acquisition unit 1003 notifies the site manager of the request for change. The site manager chooses whether or not to accept the change request and inputs it to the work management device 10 (step S216).

When the site manager does not accept the change request (step S216; NO), the work area acquisition unit 1003 returns its indication to the terminal device 2 of the object operation machine and returns the processing to step S215.

When the site manager accepts the change request (step S216; YES), the work area acquisition unit 1003 updates the planned work position of the object operation machine to the position designated by the change request in step S215 (step S214).

When there has been no change instruction from the site manager (step S212; NO) and there has been no change request from the operator (step S215; NO), the work area acquisition unit 1003 progresses the processing to the next processing without updating the planned work position (step S214).

In this way, the work area acquisition unit 1003 acquires the planned work position of the object operation machine on the basis of the request (change request) from the operator.

Next, the work area acquisition unit 1003 determines the work area using the planned work position determined on the basis of each processing from step S210 to step S216 as a reference (step S217). A specific example of the processing of step S217 will be described with reference to FIG. 8.

The point P illustrated in FIG. 8 is a planned operation position determined for the object operation machine through each processing from step S210 to step S216. Hereinafter, the point P illustrated in FIG. 8 will be referred to as a planned operation position P. The work area acquisition unit 1003 defines a square having a length of one side of “L” centered on the planned operation position P. At this time, the work area acquisition unit 1003 sets an area of a square having a length of one side of L as a value of a “work area largeness” recorded in the operation machine information D3.

In this way, the work area acquisition unit 1003 determines a work area AR of the object operation machine on the basis of the planned work position P of the object operation machine at the work site F.

Further, in the work site F, a direction in which a square as the work area AR is disposed can be appropriately determined from an azimuth angle based on the GNSS information of the object operation machine.

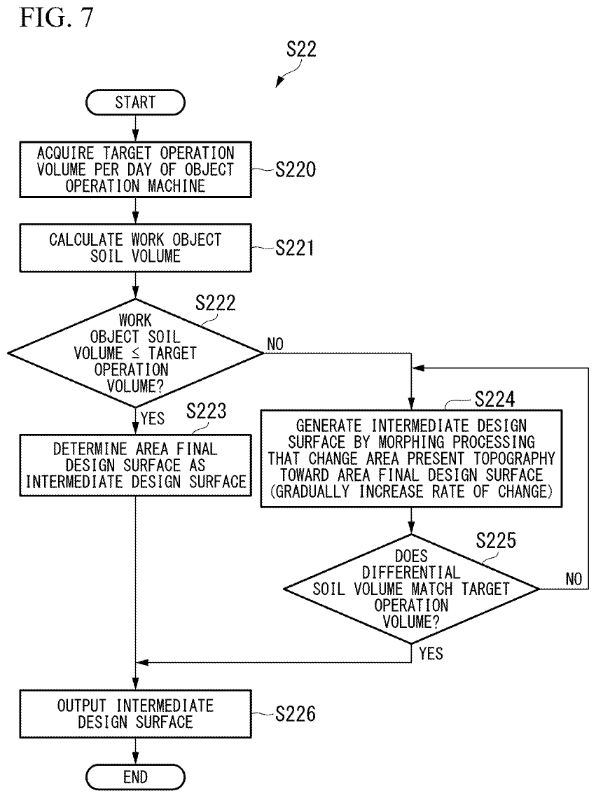

The intermediate design surface generation/output subroutine (step S22) will be described in detail with reference to FIG. 7.

The target operation volume acquisition unit 1004 of the work management device 10 refers to the operation machine information D3 and acquires a target operation volume per day of the object operation machine (step S220).

Next, the intermediate design surface generation unit 1005 of the work management device 10 calculates a work object soil volume of the object operation machine (step S221). The term “work object soil volume” indicates a total volume of soil to be excavated to form the final design surface from the present topography in a region of the work area AR assigned to the object operation machine. The processing of step S221 will be described in detail with reference to FIG. 9.

FIG. 9 illustrates an object operation machine 1N, an area present topography D1a, and an area final design surface D2a.

The area present topography D1a is topographical information of a region belonging to the work area AR of the object operation machine 1N amid the present topography D1 acquired in step S0 (FIG. 4).

The area final design surface D2a is topographical information of a region belonging to the work area AR of the object operation machine 1N amid the final design surface D2 acquired in step S1 (FIG. 4).

As illustrated in FIG. 9, the intermediate design surface generation unit 1005 calculates a differential soil volume between the area present topography Dla and the area final design surface D2a as the work object soil volume of the object operation machine 1N.

Referring to FIG. 7 again, next, the intermediate design surface generation unit 1005 determines whether or not the work object soil volume calculated in step S221 is equal to or less than the target operation volume per day of the object operation machine (step SS222).

When the work object soil volume has been determined to be equal to or less than the target operation volume per day of the object operation machine (step S222; YES), the intermediate design surface generation unit 1005 determines the area final design surface D2a (FIG. 9) as the intermediate design surface (step S223).

On the other hand, when the work object soil volume has been determined to be larger than the target operation volume per day of the object operation machine (step S222; NO), the intermediate design surface generation unit 1005 performs three-dimensional morphing processing that smoothly (continuously) changes the area present topography D1a (FIG. 9) toward the area final design surface D2a to generate the intermediate design surface. The intermediate design surface generation unit 1005 increases a rate of change by a predetermined minute value (for example, 1%) in the three-dimensional morphing processing (step S224). Here, the term “rate of change” is a parameter indicating a degree of change in shape in the three-dimensional morphing processing. For example, in a case of “rate of change: 0%,” the intermediate design surface is the area present topography D1a itself, and in a case of “rate of change: 100%,” the intermediate design surface is the area final design surface D2a itself.

Next, the intermediate design surface generation unit 1005 calculates the differential soil volume between the intermediate design surface generated in step S224 and the area present topography D1a. Then, it is determined whether or not the differential soil volume between the intermediate design surface and the area present topography D1a matches the target operation volume per day acquired in step S220 (step S225).

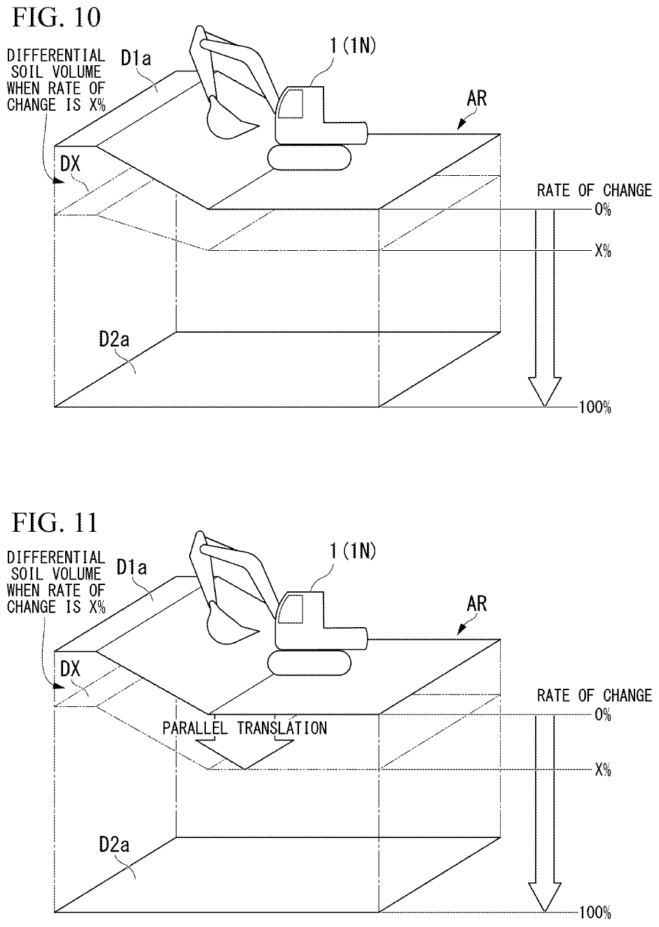

When the differential soil volume between the intermediate design surface and the area present topography D1a does not match the target operation volume per day acquired in step S220 (step S225; NO), the intermediate design surface generation unit 1005 returns the processing to step S224 and additionally increases the rate of change by a minute value. That is, the intermediate design surface generation unit 1005 increases the rate of change by repeating the processing of step S224 to step S225 until the differential soil volume between the intermediate design surface and the area present topography D1a matches the target operation volume per day. The processing of step S224 and step S225 will be described in detail with reference to FIG. 10.

FIG. 10 further illustrates an intermediate design surface DX in addition to the object operation machine 1N, the area present topography D1a, and the area final design surface D2a.

The intermediate design surface DX is topographical information generated by the three-dimensional morphing processing that changes the area present topography D1a toward the area final design surface D2a. FIG. 10 illustrates the intermediate design surface DX at the time when the morphing processing has progressed to a certain rate of change X % (0<X<100). In this way, the intermediate design surface generation unit 1005 generates the intermediate design surface by morphing the present topography toward the final design surface.

In step S225, the intermediate design surface generation unit 1005 calculates the differential soil volume between the area present topography D1a and the intermediate design surface DX as illustrated in FIG. 10. The intermediate design surface generation unit 1005 generates the intermediate design surface DX such that the differential soil volume matches the target operation volume per day of the object operation machine by repeating the processing of step S224 to step S225.

Referring to FIG. 7 again, next, the notification processing unit 1006 of the work management device 10 transmits the generated intermediate design surface to the object operation machine (step S226). When the object operation machine is the subordinate operation machine 1B, this intermediate design surface is displayed on the terminal device 2 of the subordinate operation machine 1B. When the object operation machine is the lead operation machine 1A, the intermediate design surface is displayed on a monitor or the like mounted on the lead operation machine 1A. Thereby, the operator of the object operation machine can recognize the intermediate design surface which is a goal of the work for the day.

### Operation and Effects

As described above, the work management device 10 according to the first embodiment includes the present topography acquisition unit 1001 which acquires the present topography D1 at the work site F, the final design surface acquisition unit 1002 which acquires the final design surface D2 at the work site F, the work area acquisition unit 1003 which acquires the work area AR of the operation machine 1 at the work site F, the target operation volume acquisition unit 1004 which acquires a target operation volume per unit time (per day) of the operation machine 1, the intermediate design surface generation unit 1005 which generates the intermediate design surface DX for the operation machine 1 on the basis of the present topography D1, the final design surface D2, the work area AR, and the target operation volume per unit time, and the notification processing unit 1006 which notifies the intermediate design surface DX to an operator of the operation machine 1 (the lead operation machine lA and the subordinate operation machine 1B).

According to such a configuration, each operation machine is notified of an intermediate design surface in which characteristics peculiar to an operation machine such as a work area and a target operation volume are taken into consideration. Therefore, a goal for a unit time for each of the plurality of operation machines can be appropriately set.

### Modified Example

The work management device 10 according to the first embodiment has been described in detail above, but the specific aspect of the work management device 10 is not limited to those described above, and various design changes or the like can be made within a range not departing from the gist.

For example, the work area acquisition unit 1003 according to the first embodiment has determined a square plot having the length of one side of L with the planned operation position P as a reference as the work area AR, but the present invention is not limited to this aspect in other embodiments. The work area acquisition unit 1003 according to another embodiment may determine a circular plot having a diameter L with the planned operation position P as a reference as the work area AR. Also, the work area AR may have an arbitrary shape that does not belong to a rectangle or a circle. Also, the work area acquisition unit 1003 according to still another embodiment may determine a plot having a different shape for each operation machine 1 as the work area AR of the operation machine 1.

Also, the work area acquisition unit 1003 according to yet another embodiment may determine a predetermined plot or a plot directly designated by the work manager or the like as the work area AR regardless of the planned operation position P. In this case, the processing for provisionally determining the planned work position from the present position of the operation machine (step S210 and step S211 shown in FIG. 6) is not indispensable.

Also, in the work management device 10 according to the first embodiment, the target operation volume per day of each operation machine 1 has been described as being a value specified in advance by the operation machine information D3, but the present invention is not limited to this aspect in other embodiments.

For example, if the present topography D1 updated for each day is compared from each other, it is possible to obtain a soil volume actually excavated during the operation of one day in the work area AR that each operation machine 1 is in charge of. The work management device 10 according to another embodiment may determine the target operation volume per day of each operation machine 1 on the basis of an actual value of the soil volume excavated in the operation of one day in the past. In this way, accuracy of the target operation volume per day recorded in the operation machine information D3 can be improved. Moreover, in still another embodiment, the target operation volume per day may be adjusted to be increased or decreased according to skill of the operator (setting such as “apprentice” or “experienced”).

The work management device 10 according to the first embodiment has been described as smoothly changing the three-dimensional present topography to the final design surface in the work area AR using the morphing processing, but the present invention is not limited to this aspect in other embodiments.

FIG. 11 is a view used for a detailed description on the processing of the work management device according to a modified example of the first embodiment.

As illustrated in FIG. 11, the intermediate design surface generation unit 1005 of the work management device 10 according to another embodiment may generate the intermediate design surface DX by translating the area present topography D1a in a vertical direction.

Also, the intermediate design surface generation unit 1005 of the work management device 10 according to another embodiment may generate the intermediate design surface DX by translating the area final design surface D2a in the vertical direction.

Also, the direction of parallel translation in the above-described modified example is not limited to the vertical direction, and the parallel translation may be performed in any direction according to a topographical shape.

Also, the work management device 10 according to the first embodiment has been described as being mounted on the operation machine 1 (the lead operation machine 1A) and the operator of the lead operation machine 1A has been described as working as the site manager, but the present invention is not limited to this aspect in other embodiments. For example, the work management device 10 may be disposed in a remote location such as a computer disposed in an office of the work company or a server of a company providing such a work management service. Also, the site manager may be a person different from the operator of the operation machine.

Further, even if the work management device 10 is mounted on the operation machine 1, the work management device 10 may also have an aspect in which information of various types (the present topography D1, the final design surface D2, and the operation machine information D3) to be referred to is received from the server device 4 each time it is necessary in the process of generating the intermediate design surface.

Also, the work management device 10 according to the first embodiment has been described as directly acquiring the target operation volume per day from the operation machine information D3 (step S220 in FIG. 7) in the intermediate design surface generation/output subroutine (step S22 in FIG. 5). However, the present invention is not limited to this aspect in other embodiments.

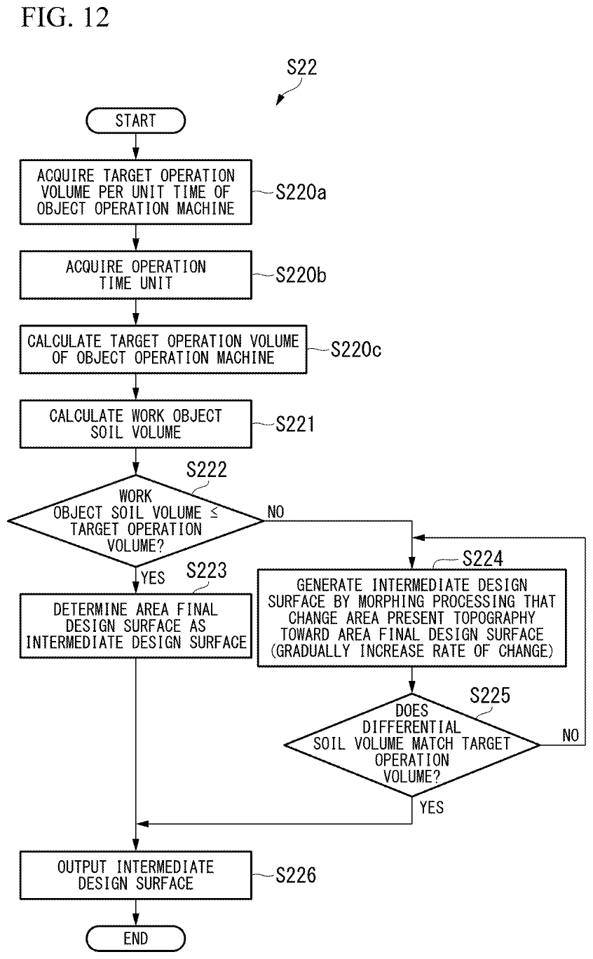

FIG. 12 is a diagram used for a detailed description on the processing (the intermediate design surface generation/output subroutine) of the work management device according to the modified example of the first embodiment.

For example, it is assumed that a unit time other than one day (for example, a target operation volume per hour) is recorded in the operation machine information D3 according to the modified example. In this case, as shown in FIG. 12, the work management device 10 first acquires a target operation volume per unit time (per hour) of the object operation machine 1N from the operation machine information D3 (step S220a). Next, the work management device 10 acquires an operation time unit (for example, 8 hours) of the object operation machine 1N for the day (step S220b). Then, the work management device 10 multiplies the target operation volume per unit time acquired in step S220a by the operation time unit acquired in step S220b to calculate the target operation volume of the object operation machine 1N for the day (step S220c).

Since processing after step S221 in FIG. 12 is the same as those in the first embodiment, description thereof will be omitted.

Also, in the first embodiment, a case in which the final design surface is formed from the present topography by “excavation” has been described as an example, but the present invention is not limited thereto in other embodiments. The work management device 10 according to another embodiment can also be applied to, for example, a case in which the final design surface is formed from the present topography by “filling.” In this case, a target operation volume when the operation machine performs “filling” is recorded as the target operation volume per day in the operation machine information D3.

Further, processes of the processing of various types by the work management device 10 described above are stored in a computer-readable recording medium in a form of a program, and the above-described processing of various types are performed by the computer reading and executing the program. Also, the computer-readable recording medium refers to a magnetic disk, a magneto-optical disk, a CD-ROM, a DVD-ROM, a semiconductor memory, or the like. Also, this computer program may be distributed to computers via a communication link, and a computer receiving the distribution may execute the program.

The above-described program may be a program for realizing a part of the above-described functions. Further, the above-described program may be a so-called differential file, differential program, or the like which can realize the above-described functions in combination with a program already recorded on the computer system.

While preferred embodiments of the present invention have been described, it should be understood that these embodiments are exemplary of the invention and are not to be considered as limiting the scope of the invention. The embodiments may be implemented in many other different forms, and various omissions, substitutions, and modifications can be made without departing from the gist of the invention. The embodiments and modifications thereof should be regarded as being included within the scope and gist of the invention and included in the invention described in the claims and equivalent scope thereof.

### INDUSTRIAL APPLICABILITY

According to the present invention, it is possible to appropriately set a target of work for a unit time for each of a plurality of operation machines.

### REFERENCE SIGNS LIST

1 Operation machine
10 Work management device
100 CPU
1001 Present topography acquisition unit
1002 Final design surface acquisition unit
1003 Work area acquisition unit
1004 Target operation volume acquisition unit
1005 Intermediate design surface generation unit
1006 Notification processing unit
101 Wireless communication interface
102 Recording medium
2 Terminal device
3 Edge processing computer
4 Server device
5 Computer of work company
9 Work management system

1. A work management device comprising:
a present topography acquisition unit which acquires a present topography at a work site;
a final design surface acquisition unit which acquires a final design surface at the work site;
a work area acquisition unit which acquires a work area of an operation machine at the work site;
a target operation volume acquisition unit which acquires a target operation volume per unit time of the operation machine;
an intermediate design surface generation unit which generates an intermediate design surface for the operation machine on the basis of the final design surface, the present topography, the work area, and the target operation volume per unit time; and
a notification processing unit which notifies the intermediate design surface to an operator of the operation machine.

2. The work management device according to claim 1, wherein the intermediate design surface generation unit generates the intermediate design surface such that a differential soil volume between the present topography and the intermediate design surface in the work area matches the target operation volume per unit time.

3. The work management device according to claim 1, wherein the work area acquisition unit determines the work area on the basis of a planned work position of the operation machine at the work site.

4. The work management device according to claim 3, wherein the work area acquisition unit acquires the planned work position on the basis of a request from the operator.

5. The work management device according to claim 3, wherein the work area acquisition unit acquires the planned work position on the basis of an instruction from a site manager to the operator.

6. The work management device according to claim 1, wherein the intermediate design surface generation unit generates the intermediate design surface by morphing the present topography toward the final design surface.

7. The work management device according to claim 1, wherein the target operation volume acquisition unit determines a target operation volume per unit time on the basis of past performance of the operation machine.

8. A work management system comprising:
the work management device according to claim 1; and
a terminal device which displays the intermediate design surface received from the work management device.

9. An operation machine comprising the work management device according to claim 1.

10. A work management method comprising:
a step of acquiring a present topography at a work site;
a step of acquiring a final design surface at the work site;
a step of acquiring a work area of an operation machine at the work site;
a step of acquiring a target operation volume per unit time of the operation machine;
a step of generating an intermediate design surface for the operation machine on the basis of the final design surface, the present topography, the work area, and the target operation volume per unit time; and
a step of notifying the intermediate design surface to an operator who performs work using the operation machine.

11. A program which causes a computer of a work management device to execute:
a step of acquiring a present topography at a work site;
a step of acquiring a final design surface at the work site;
a step of acquiring a work area of an operation machine at the work site;
a step of acquiring a target operation volume per unit time of the operation machine;
a step of generating an intermediate design surface for the operation machine on the basis of the final design surface, the present topography, the work area, and the target operation volume per unit time; and
a step of notifying the intermediate design surface to an operator who performs work using the operation machine.

12. The work management device according to claim 2, wherein the work area acquisition unit determines the work area on the basis of a planned work position of the operation machine at the work site.

13. The work management device according to claim 4, wherein the work area acquisition unit acquires the planned work position on the basis of an instruction from a site manager to the operator.

14. The work management device according to claim 2, wherein the intermediate design surface generation unit generates the intermediate design surface by morphing the present topography toward the final design surface.

15. The work management device according to claim 3, wherein the intermediate design surface generation unit generates the intermediate design surface by morphing the present topography toward the final design surface.

16. The work management device according to claim 2, wherein the target operation volume acquisition unit determines a target operation volume per unit time on the basis of past performance of the operation machine.

17. The work management device according to claim 3, wherein the target operation volume acquisition unit determines a target operation volume per unit time on the basis of past performance of the operation machine.

18. A work management system comprising:
the work management device according to claim 2; and
a terminal device which displays the intermediate design surface received from the work management device.

19. A work management system comprising:
the work management device according to claim 3; and
a terminal device which displays the intermediate design surface received from the work management device.

20. An operation machine comprising the work management device according to claim 2.
